(19) United States
(12) Patent Application Publication
(10) Pub. No.: US 2026/0135981 A1
(43) Pub. Date: May 14, 2026

(54) MULTI-VIEW VOLUMETRIC VIDEO CAPTURE WITH SPARSE CAMERA CONFIGURATIONS

(71) Applicant: DOLBY LABORATORIES LICENSING CORPORATION, San Francisco, CA (US)

(72) Inventors: Yu LIU, Cupertino, CA (US); Sandeep BANGALORE VENKATESH, Sunnyvale, CA (US); Guan-Ming SU, Fremont, CA (US)

(73) Assignee: DOLBY LABORATORIES LICENSING CORPORATION, San Francisco, CA (US)

(21) Appl. No.: 19/381,237

(22) Filed: Nov. 6, 2025

Related U.S. Application Data
(60) Provisional application No. 63/719,967, filed on Nov. 13, 2024.
(60) Provisional application No. 63/766,628, filed on Mar. 4, 2025.

(30) Foreign Application Priority Data
Mar. 7, 2025 (EP) 25162458.1

(51) Int. Cl. H04N 13/243; H04N 13/275; H04N 23/617

(52) U.S. Cl. CPC H04N 13/243; H04N 13/275; H04N 23/617

(57) ABSTRACT

Examples, aspects, and instances of selecting camera configurations for volumetric video and 3D model recreation. One example method includes receiving a 3D model and identifying a reconstruction quality metric with which to reconstruct the 3D model. The method includes selecting a set of cameras, each camera having a different view of the 3D model, that maximizes the reconstruction quality metric. In some instances, a number of cameras in the set of cameras is less than a total number of available cameras. The number of cameras may be a set number (for example, input by a content creator), may be less than a set threshold of maximum cameras, may be a subset of a maximum number of available cameras, or the like.

### 1. CROSS-REFERENCE TO RELATED APPLICATIONS

This application claims the benefit of European Patent Application No. 25162458.1, filed Mar. 7, 2025, U.S. Provisional Patent Application No. 63/766,628, filed Mar. 4, 2025, and U.S. Provisional Patent Application No. 63/719,967, filed Nov. 13, 2024, the entire contents of each of which is hereby incorporated by reference.

### 2. FIELD OF THE DISCLOSURE

Various example embodiments relate to identifying a sparse camera arrangement for volumetric video.

### SUMMARY

Disclosed herein are various embodiments of selecting camera configurations for volumetric video and three-dimensional (3D) model recreation. One example method includes receiving a 3D model and identifying a reconstruction quality metric with which to reconstruct the 3D model. The method includes selecting a set of cameras, each camera having a different view of the 3D model, that maximizes the reconstruction quality metric. In some instances, a number of cameras in the set of cameras is less than a total number of available cameras. The number of cameras may be a set number (for example, input by a content creator), may be less than a set threshold of maximum cameras, may be a subset of a maximum number of available cameras, or the like.

Another example provides a method for selecting a camera configuration. The method includes receiving a plurality of camera views, each camera view associated with a camera included in an array of cameras capturing a three-dimensional (3D) model and determining, for each camera view of the plurality of camera views, a camera feature associated with a complexity of the 3D model captured by the camera view. The method also includes receiving a target number of camera views, performing an optimization operation on a utility function to generate a subset of camera views, and transmitting the subset of camera views to a rendering device. The utility function is based on the complexity of the 3D model captured by each camera view, a spatial distribution between the plurality of camera views, and the target number of camera views.

Another example method provides a method of encoding a three-dimensional (3D) model. The method includes receiving a camera view capturing the 3D model, generating a camera feature representative of an image complexity and spatial distribution associated with the camera view, and transmitting the camera feature to a decoding device.

A further example provides a method of selecting a camera configuration. The method includes receiving a plurality of camera features associated with a plurality of camera views, receiving a target number of cameras less than a total number of the plurality of camera views, determining a subset of camera views based on the camera features, and transmitting the subset of camera views to a rendering device. The number of camera views included in the subset of camera views is equal to the target number of cameras.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 illustrates an example video capture environment, according to some aspects of the disclosure herein.

FIG. 2 illustrates an example video capture environment including a camera array, according to some aspects of the disclosure herein.

FIG. 3 illustrates example views captured by cameras in the camera array of FIG. 2, according to some aspects of the disclosure herein.

FIG. 4 illustrates an example NeRF workflow, according to some aspects of the disclosure herein.

FIG. 5 illustrates an example Instant-NGP workflow, according to some aspects of the disclosure herein.

FIG. 6 illustrates an example sample of cameras with Tammes views, according to some aspects of the disclosure herein.

FIG. 7 and FIG. 8 illustrate example asymmetric and complex objects, according to some aspects of the disclosure herein.

FIG. 9 is a block diagram illustrating an example encoding-decoding framework, according to some aspects of the disclosure herein.

FIG. 10A illustrates a heatmap of image complexity of an RGB view of each camera imaging an object, according to some aspects of the disclosure herein.

FIGS. 10B-10D illustrate views of the object corresponding to FIG. 10A, according to some aspects of the disclosure herein.

FIGS. 11A-11D illustrate the normal map view corresponding to the heatmap and object shown in FIGS. 10A-10D, according to some aspects of the disclosure herein.

FIG. 12 illustrates example pseudocode for a greedy algorithm implemented by the decoder, according to some aspects of the disclosure herein.

FIG. 13A illustrates the peak signal-to-noise ratio (PSNR) related to the number of cameras for the object of FIG. 7, according to some aspects of the disclosure herein.

FIG. 13B illustrates the structural similarity index measure (SSIM) related to the number of cameras for the object of FIG. 7, according to some aspects of the disclosure herein.

FIG. 14 illustrates a visualized view of camera positions corresponding to the examples of FIGS. 13A and 13B, according to some aspects of the disclosure herein.

FIGS. 15A and 15B illustrate example sigmoid functions, according to some aspects of the disclosure herein.

FIG. 16 is a flow chart illustrating a method performed by each encoder of FIG. 9, according to some aspects of the disclosure herein.

FIG. 17 is a flow chart illustrating a method performed by the decoder of FIG. 9, according to some aspects of the disclosure herein.

FIG. 18 is a flow chart illustrating a method for selecting a sparse camera view, according to some aspects of the disclosure herein.

FIG. 19 is a flow chart illustrating another method for selecting a sparse camera view, according to some aspects of the disclosure herein.

FIG. 20 illustrates example candidate views and evaluation views for an example implementation, according to some aspects of the disclosure herein.

FIG. 21 illustrates graphs of the PSNR and SSIM values of several objects for an example implementation, according to some aspects of the disclosure herein.

FIG. 22 illustrates a visualization of an object with different view counts, according to some aspects of the disclosure herein.

FIG. 23 illustrates a visualization of another object with different view counts, according to some aspects of the disclosure herein.

FIG. 24 illustrates graphs of the PSNR and SSIM values of the complex scene of FIG. 8, according to some aspects of the disclosure herein.

FIG. 25 illustrates a visualization of the complex scene of FIG. 8 with different view counts, according to some aspects of the disclosure herein.

FIG. 26 illustrates a block diagram of an example apparatus, according to some aspects of the disclosure herein.

### DETAILED DESCRIPTION

Capturing and creating high-quality and realistic three-dimensional (3D) models and videos of real-world objects is a crucial part of virtual reality applications, such as the metaverse. Compared to other immersive video formats such as panoramic videos and light-field videos, where the transitional movement is limited, volumetric videos support fully 3D representation of the captured objects and scenes and allow viewers to perceive the video from any position and directions. However, the current volumetric video representations method is still sub-optimal. Volumetric videos are commonly represented as a series of 3D-meshes or point clouds in its time series, capturing the dynamics of objects over time. Both representations incur higher data volume compared to traditional 2D videos. Moreover, the encoding algorithms for 3D meshes or point clouds are still in early-development phases, resulting in a lower compression ratio and higher computing overhead.

Recently, Neural Radiance Fields (NeRF) method has emerged as an alternative representation of volumetric videos. NeRF leverages a neural network to generate synthetic novel view of a 3D object or scene based on a series of input views taken from different positions and directions. A fine-tuned NeRF model can generate high-quality and realistic renderings of views from arbitrary positions and directions with dedicated lighting effects and detailed textures. The volumetric video can therefore be represented by creating a NeRF model of the captured scene at each time frame.

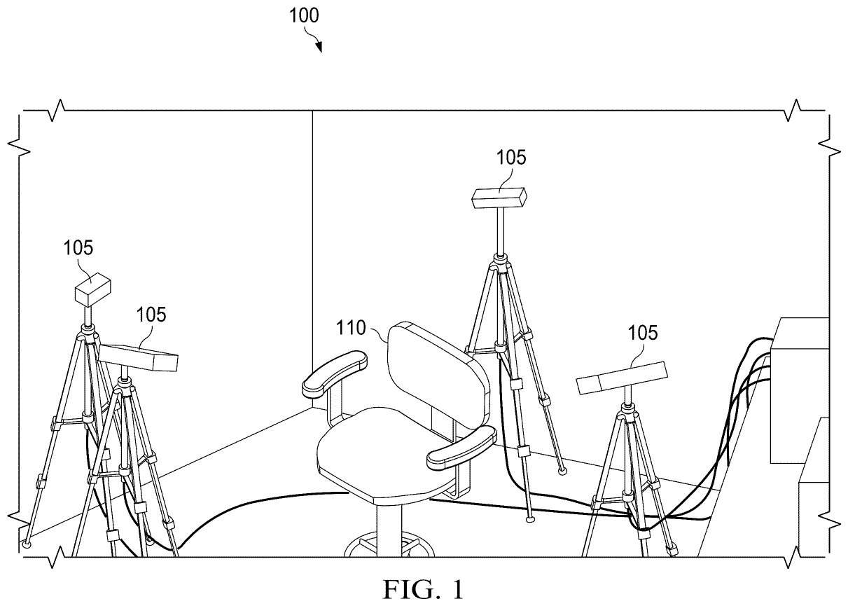

Despite the high potential of NeRF-based representation of volumetric video, capturing a NeRF-based volumetric video is challenging compared to the traditional representation. Capturing a 3D-mesh or point cloud volumetric video typically requires as less as 3 cameras for the full 3D structure. For example, FIG. 1 illustrates an example video capture environment 100. The video capture environment 100 includes a plurality of cameras 105 for capturing an object of interest 110. While the plurality of cameras 105 in FIG. 1 includes four cameras 105, as few as 3 cameras may be used to capture the object of interest 110.

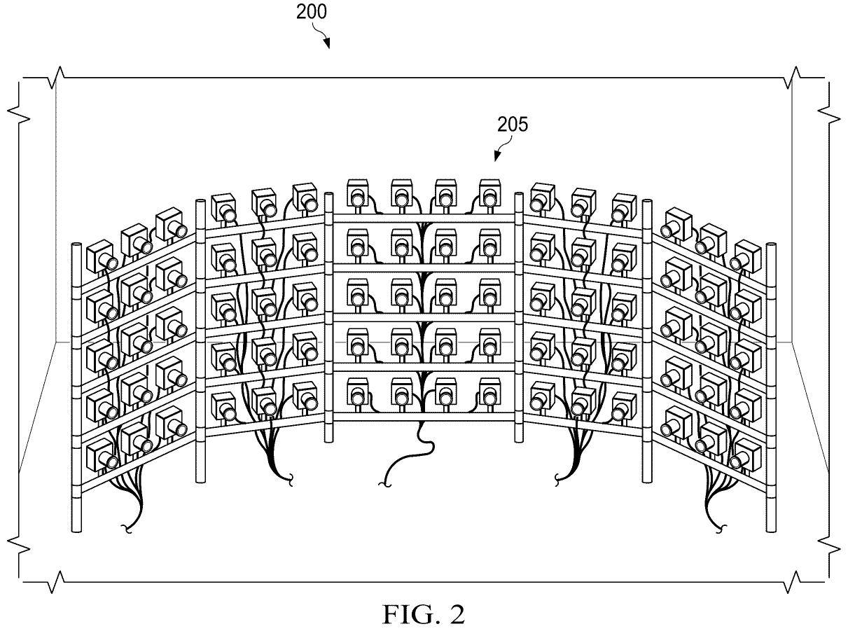

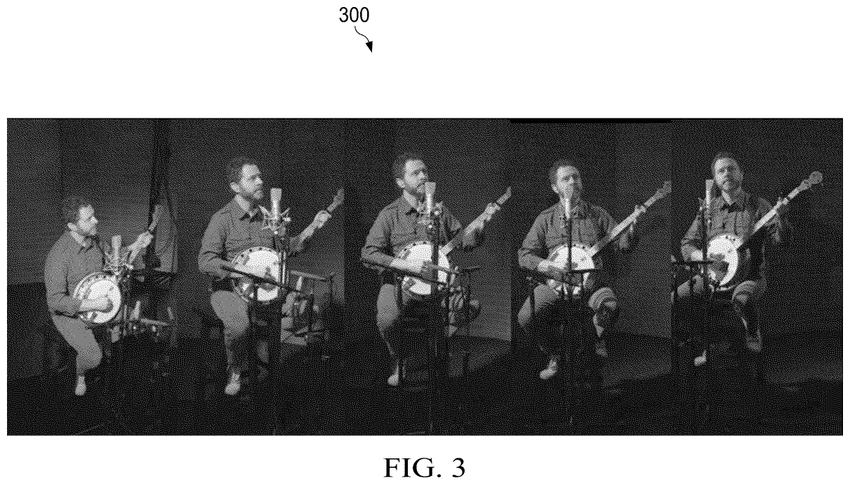

For the NeRF-based volumetric video, a denser camera array is required for the model to generate high-quality rendering outputs. For example, FIG. 2 illustrates an example video capture environment 200 having a camera array 205. As shown in FIG. 2, the capturing setup features fifty cameras in the camera array 205 to capture only the front side of the capturing scene. Example camera arrays described herein may also include fewer or more than fifty cameras. However, setting up the camera array 205 increases the cost for volumetric video capture. Capturing with such dense cameras may result in high redundancy in the captured views. For example, FIG. 3 illustrates example views 300 captured by the camera array 205. As seen in the views 300, several views capture similar data. Use of the camera array 205 also incurs a much higher storage requirement for the raw data, and training NeRF model will be more time consuming and require higher computational resources.

Examples, aspects, and instances described herein provide a learning-based framework for improving NeRF-based volumetric video capturing by suggesting a sparser camera arrangement. Frameworks described herein may suggest a sparser camera array based on an existing dense camera array while maintaining a high visual quality. Frameworks described herein may encode each camera into the feature space, then decode the best camera combination based on a target number of cameras. A simplified decoder algorithm may be provided with simple features picked based on heuristics and observations.

Accordingly, examples described herein provide a learning-based framework for improving the camera configurations for NeRF-based volumetric video capture, provide a simplified decoder algorithm with camera features, and provide improvements over prior NeRF-based video capture.

### Definitions and Implemented Algorithms

Volumetric videos feature a series of 3D models and capture the dynamics of the objects and scenes in a time series. The representations of volumetric videos may be 3D meshes and point clouds. 3D meshes contain a collection of vertices, edges, and faces to capture the surface of 3D objects. Point clouds consist of a collection of unordered points in space to capture the 3D shapes. However, point cloud representation lacks spatial connectivity and may result in holes, which leads to lower visual quality. Moreover, the two representations cannot model occlusion and lighting well, making it difficult to create photorealistic 3D representations of real-world scenes.

Another drawback of the two representations is the data volume and compression efficiency. Both 3D meshes and point clouds incur much higher data volume than traditional 2D or panoramic videos. State-of-the-art compression algorithms are sub-optimal without GPU acceleration, incurring higher computational overhead and achieving lower compression ratio. As a result, current volumetric video representations have higher storage requirements and are not capable of being commercially applied in real-world applications, such as live streaming.

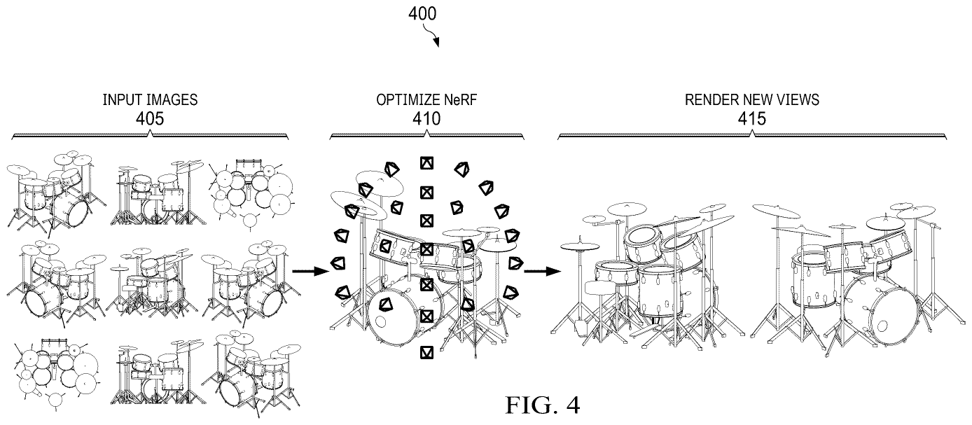

Neural Radiance Fields (NeRFs) achieve high-quality, photorealistic views synthesized from a complex volumetric scene by representing the volumetric scene as a fully connected deep neural network. FIG. 4 illustrates an example NeRF workflow 400. Each view is synthesized (at step 405) by querying the network with a 5D input (e.g., spatial location x, y, z and viewing direction θ, φ) and then performing volume rendering of the color on each ray passing through the scene (at step 410). The view is then fully rendered (at step 415). NeRF is memory efficient and only requires a set of RGB images along with their pose as the training set.

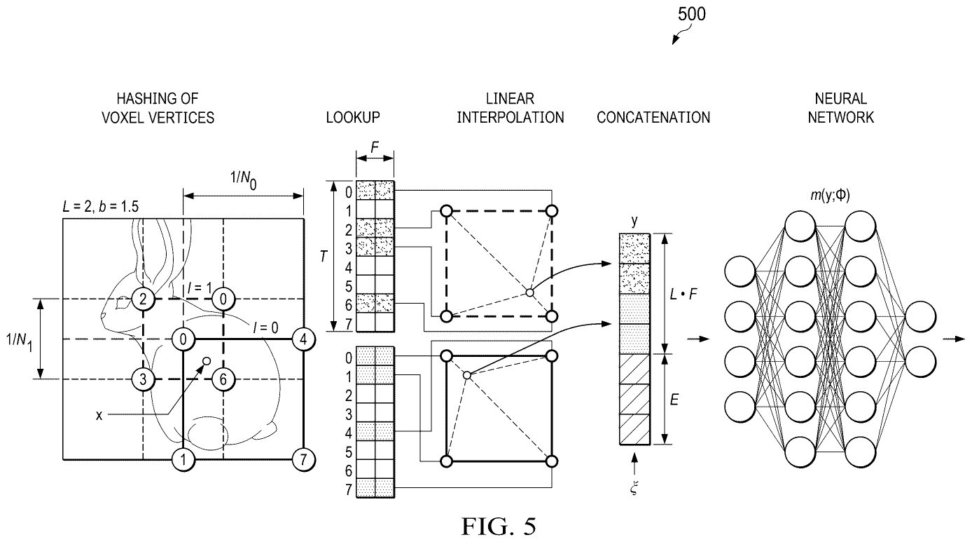

Instant Neural Graphics Primitives (Instant-NGP) is a recent advancement in neural rendering field. The traditional NeRF models can be costly to train and evaluate and may not achieve real-time training and rendering. Instant-NGP reduces the cost with a multi-resolution hash table encoding of the input, which allows the use of smaller network and reduces the number of float value calculation. FIG. 5 illustrates an example Instant-NGP workflow 500. Instant-NGP achieves high efficiency and enables high resolution rendering, allowing training and rendering in time-constraint cases such as online training. Examples described herein may use NeRFs or Instant-NGP.

### Evaluation Metrics

The two common metrics for evaluating the performance of NeRF models are Peak Signal-to-Noise Ratio (PSNR) and Structural Similarity Index Measure (SSIM).

PSNR measures the ratio between the maximum possible power of an image and is defined according to Equation (1):

$$PSNR = 10 \cdot {log}_{10} \frac{{MAX}_{I}^{2}}{MSE} \qquad Equation ( 1 )$$

where I denotes an image;
where MSE is defined as;

$$MSE = \frac{1}{mn} {\sum }_{i = 0}^{m - 1} {\sum }_{j = 0}^{n - 1} {[ I ( i , j ) - K ( i , j ) ]}^{2} ;$$

and
where K denotes the power of the corrupting noise of the image I.

PSNR is usually applied to evaluate the quality of lossy codecs compression. The typical range of PSNR is 30 to 50 dB with 8-bit depth. The acceptable values for transmission quality loss is about 20 dB to 25 dB.

SSIM measures the similarity between two images and is defined according to Equation (2):

$$SSIM ( x , y ) = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )} \qquad Equation ( 2 )$$

where μ is the pixel sample mean, σₓ is the variance of x, σ_{xy} is the covariance of xy, c₁=(k₁L)² and c₂=(k₂L)² are two variables to stabilize the division. A SSIM value higher than 0.98 typically means visually unimpaired.

Fréchet inception distance (FID) may be applied to assess the quality of images created by generative models such as generative adversarial network (GAN). FID evaluates the distribution of generated images comparing with the distribution of ground truth images. FID is defined according to Equation (3):

$${d}_{F} ( μ , v ) := {( {inf}_{γ ∈ Γ ( μ , v )} {\int }_{{R}^{n} \times {R}^{n}} {\vert x - y \vert}^{2} d γ ( x , y ) )}^{1 / 2} \qquad Equation ( 3 )$$

Where Γ(μ, v) is the set of all measurements on Rⁿ×Rⁿ with marginals u, v on the first and second factors.

Learned Perceptual Image Patch Similarity (LPIPS) goes beyond the mathematical methods and measures the similarity between images based on human perception. LPIPS leverages deep learning networks and converges the images to deep features based on how humans perceive the images, then compares the perceptual similarity between images.

PSNR and SSIM are two metrics that may be used in image processing and evaluating the performance of NeRF by calculating the metrics value between the model's output and ground truth. While PSNR and SSIM are primarily referred to herein, examples described herein are not limited to these metrics of quality evaluation.

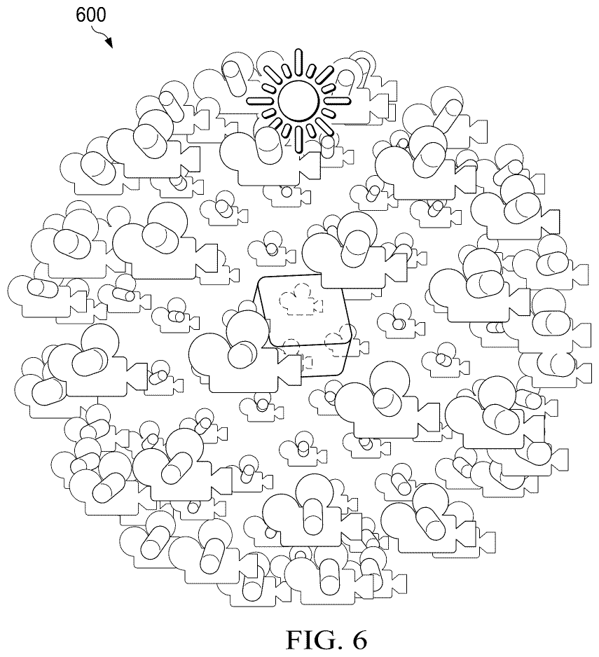

To evaluate the performance of NeRF, a set of evaluation views is identified that captures the target object from different positions and directions. To ensure that evaluation views are sufficient and uniformly distributed in space, a spherical camera view space centered at the object is implemented and the solution to the Tammes problem may be established as the set of camera positions. FIG. 6 illustrates an example sample of cameras 600 with one hundred Tammes views. Each camera 600 is facing directly to the center of the sphere. The Tammes problem finds the points on a given surface such that each point maximizes the minimum distance from all the other points. In other words, the Tammes problem identifies the most uniformly distributed points on the given surface. The Tammes views may also be applied for evaluating the performance of NeRF models.

### Camera Configurations

View planning has been an important consideration for 3D reconstruction. Most known view planning systems take the approach of finding the next-best-view (NBV) by iteratively performing 3D reconstruction at each step and selecting the next view that has the highest uncertainty or achieves the highest predicted reconstruction performance. This method requires repeatedly constructing the 3D model and evaluating the performance, which is time-consuming and demands high computational resources. Moreover, those solutions only target a static capturing scene and may not be able to apply for cases where the capturing scenes are highly dynamic, such as volumetric video.

To address this issue, some known techniques have been focused on planning views and cameras without repeatedly reconstructing the 3D scene. PRVNet, for example, predicts the number of views required to capture a certain 3D object given three views (top, left, and front) of the object. With the suggested number of views, PRVNet then finds the corresponding Tammes views as the suggested camera array.

Another technique, NeRF Director, revisited the view selection by conducting a concrete measurement study and observing that both the object's orientation and view selection contribute to the performance of a NeRF model. NeRF Director provides two methods for camera view selection: furthest view sampling (FVS) and information gain-based sampling.

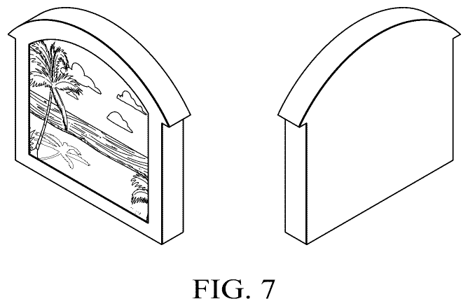

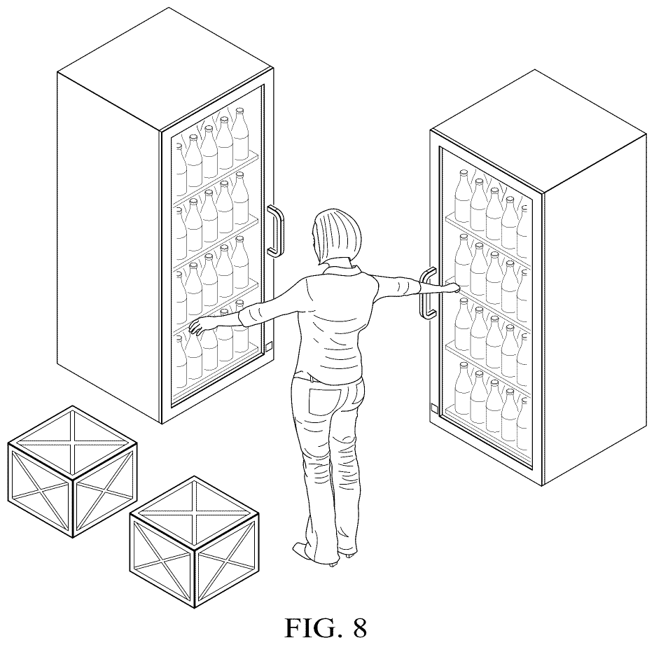

However, despite the abundant research on view selection and planning for NeRF models, many techniques neglect the complexity of 3D objects and place the views and cameras uniformly in space. In actuality, captured objects may be asymmetric and complex, such as the objects shown in FIGS. 7 and 8. In such instances, uniformly placing all views in space may lead to suboptimal results, as there will be insufficient views capturing the complex parts and redundant views capturing the simple parts. Examples, aspects, and instances described herein propose a framework that takes the spatial information of each object into consideration and provides camera view placement that is improved from known techniques.

### Optimization Problem and Framework Design

Examples, aspects, and instances described herein provide a learning-based framework that improves the neural-based multi-view volumetric video capture by suggesting a camera array having fewer views based on the input camera views. Specifically, a sparser camera array for capturing a real-world scene while maintaining the reconstruction quality of NeRF models is recommended. The spatial complexity of the captured object is considered for view placement. Accordingly, both the camera's properties (e.g., position, direction) and the view of each camera into consideration.

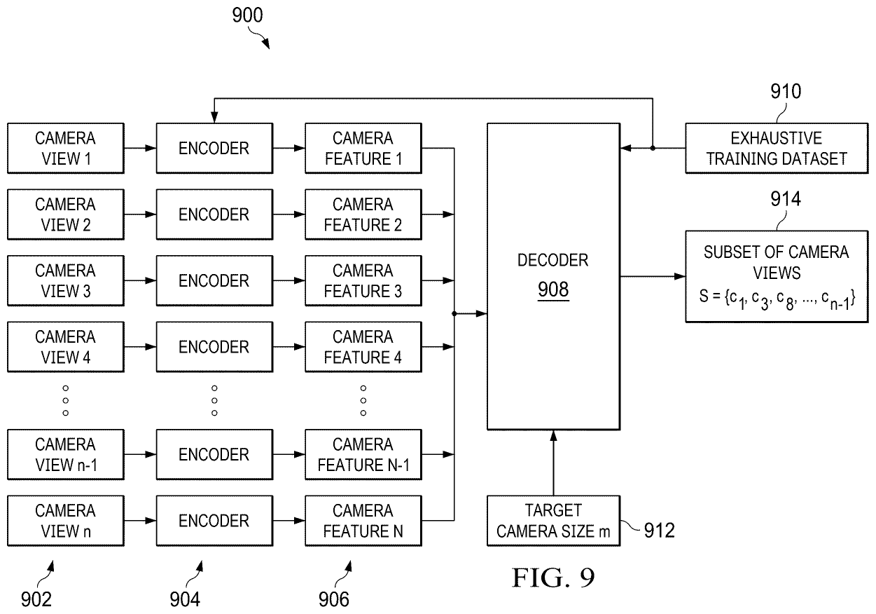

FIG. 9 is a block diagram illustrating an encoding-decoding framework 900. The framework 900 includes a plurality of camera views 902, each camera view associated with a respective camera in a camera array. The framework 900 also includes a plurality of encoders 904. Each camera view 902 is provided to a respective encoder 904. The encoder 904 receives the camera view 902 and converts the camera view 902 into camera features 906, which may be represented as latent space feature vectors.

The camera features 906 are provided to a decoder 908. For a scenario where a dense camera array is already provided, examples described herein may select a subset of the plurality of camera views 902 that maximizes the capturing quality under a given constraint. In other words, with a given dense camera set of camera views 902 (and, in some instances, given a target number of cameras 912), a subset may be identified that achieves a high reconstruction quality. This framework 900 may be applied in real-world scenarios where a capturing environment is already setup and cannot move the cameras (e.g. FIG. 2). Cameras may be turned off to reduce the number of views used for capturing and training the NeRF model.

To identify views, denote C={c₀, c₁, c₂, . . . , cₙ₋₁} as the given dense camera set, |C|=n·m as the target number of cameras and S⊆C as a subset of set C. Denote V={v₀, v₁, v₂, . . . , vₙ₋₁} as the corresponding view of each camera in set C. In addition, denote m as the target number of cameras and S⊆C as a subset of set C. |S|=m. [symbol] denotes Tammes Views with a total of N views. Denote [symbol] (S) as the NeRF model trained with views captured by cameras in set S, and

$$( S ) = \frac{1}{N} {\sum }_{j = 0}^{N - 1} PSNR ( )$$

as the quality of [symbol] (S) evaluated with average PSNR values. In other examples, rather than the average PSNR values, the reconstruction quality Q(S) may be evaluated using SSIM values of the Tammes Views, the FID of the Tammes Views, or the like.

Given a set of cameras, C, and a target number of cameras, m, determine the optimal subset of cameras, S⊆C, such that |S|=m and the reconstruction quality Q(S) is maximized according to Equation (4):

$$\begin{matrix}{max}_{S ⊂ C} ( S ) \\ s . t . \vert S \vert \leq m\end{matrix} \qquad Equation ( 4 )$$

Accordingly, the decoder 908 receives the camera features 906 and processes the camera features 906 to generate a selected subset of camera views 914. The selected subset of camera views 914 are output by the decoder 908. As noted, in some instances, the decoder 908 also receives a target number of cameras 912. In such an instance, the subset of camera views 914 includes a number of camera views equal to the received target number of cameras 912. In instances where a target number of cameras 912 is not received, the decoder 908 may minimize the number of cameras included in the subset of camera views 914 while achieving a desired reconstruction quality Q(S).

The encoder 904 and decoder 908 may be trained with an exhaustive training dataset 910 with different combinations of views with their corresponding NeRF model performance. The encoder 904 described herein may convert the input image into a camera feature 906. Extracting the camera features 906 from the camera views 902 may be achieved by applying multiple layers of convolutional layers and activation functions. The decoder 908 then selects the optimal subset based on the views' features and target number of views. A selection network may be implemented for the decoder 908, with a fully connected layer that assign the importance of each view's feature vector 906 and select the views based on certain selection criteria.

The output of framework 900 (e.g., the subset of camera views 914) may be a selected subset of the input view set C. The selection of the subset of camera views 914 by the decoder 908 may be expressed as a set of decisions D={d₀, d₁, d₂, . . . , dₙ₋₁}, where dᵢ=0 indicates cᵢ∉S, and dᵢ=1 indicates cᵢ∈S. Since the decision is a binary choice, the binary cross-entropy function may be implemented as the loss function for training the framework. To ensure a sparse selection, L1 regularization may be applied for feature selection.

For training the framework 900, the optimal subset of camera views 914 is found for each number of views m. Since the performance of NeRF model is non-linear, searching for the optimal subset for a specific m would be NP hard, and only exhaustive searches may be performed on all possible view combinations to find the optimal subset S. Meanwhile, similar to the Tammes Problem, the optimal subset may not be accumulative: the optimal subset for m may not contain all views in the optimal subset for m−1. Therefore, an exhaustive search may be performed on all possible values of m. As a result, creating the training dataset would be very time consuming. For instance, to find a m=30 optimal subset from n=180,

$$( \begin{matrix}180 \\ 30\end{matrix} ) = \frac{180 !}{30 ! \times 150 !} NeRF$$

training operations may be performed and evaluated to find the optimal combination.

In another example, the framework 900 may not include a large training by the exhaustive training dataset 910, and the exhaustive training dataset 910 may be omitted. Camera features 906 may then be selected by the encoders 904 based on heuristics, and a greedy algorithm is implemented by the decoder 908 for selecting the subset of camera views 914.

The camera feature 906 may represent image complexity and/or spatial information of the respective camera view 902. Image complexity may be referenced to represent the camera properties of each camera view 902. Image complexity (IC) measures the complexity and spatial information contains in the image. There exists multiple metrics to evaluate the image complexity, including entropy, spatial information, and lossy encoding ratio. Entropy measures how much information is contained in the image. The entropy (H) of the image may be represented as H=Σ(p(i)*log²(p(i))), where p(i) represents the probability of occurrence of the i-th intensity level in the image histogram and the summation is taken over all possible intensity levels. However, entropy fails to consider the spatial information in the image and does not accurately reflects the complexity of the image. Spatial information (SI) measures the energy of the edges in the image. The spatial information of each pixel can be represented as

$${SI}_{r} = \sqrt{{s}_{h}^{2} + {s}_{v}^{2}}$$

where sₕ and sᵥ are the grey-scale images filtered by Sober kernels. The lossy encoding ratio measures the ratio between compressed and uncompressed images' sizes and indicates the compression efficiency. The spatial information is correlated with the compression ratio. Therefore, the compression ratio may be selected as the measurement of the image complexity.

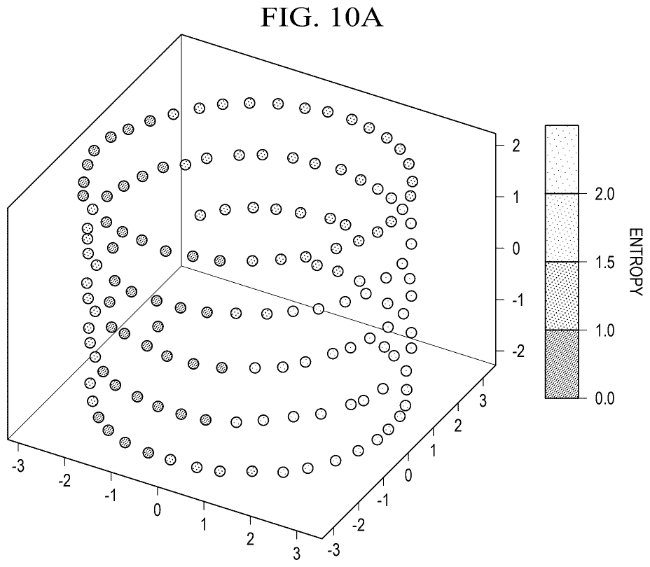

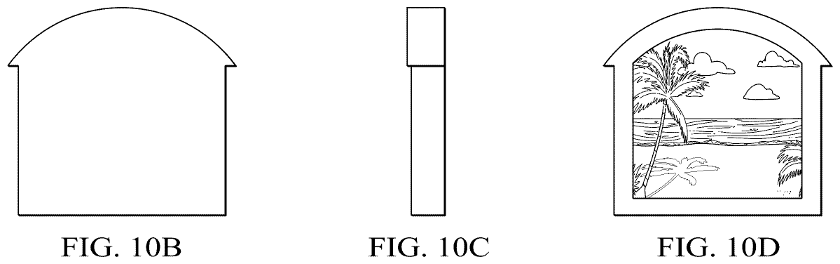

The RGB image of each camera's view 902 may be used to calculate the image complexity. However, the image complexity of the RGB images may be affected by the surface texture. For example, FIG. 10A illustrates a heatmap of image complexity of an RGB view of each camera imaging an object shown in FIGS. 10B-10D. FIG. 10B illustrates a back side of the object. FIG. 10C illustrates a left side of the object. FIG. 10D illustrates a front side of the object. The front of the object (FIG. 10D) contains the most complexity. The back of the object (FIG. 10B) should contain less spatial information than the side of the object (FIG. 10C). However, the image complexity of the back is higher due to the texture on the back side. To address this issue, the normal map of each camera's view 902 may be selected for evaluating the image complexity. FIGS. 11A-11D illustrate the normal map view corresponding to the heatmap and object shown in FIGS. 10A-10D. The normal map shows only the spatial structure of each image without textures. As shown in FIGS. 11A-11D, the image complexity of the normal map can better demonstrate the spatial information about the 3D object in each camera view 902.

Uniformly distributed views yield better NeRF reconstruction quality than random sampling. Therefore, the spatial distribution of the selected views may be considered by the encoder 904 in determining camera feature 906. The Euclidean distance between two cameras may be used to decide the spatial distribution of the cameras. The spatial distribution between two cameras cᵢ and cⱼ may be denoted as D(cᵢ,cⱼ)=|cᵢ−cⱼ|.

With the selected camera features 906, next is to decide a decision-making algorithm for the decoder. Example decision algorithms described herein find the set of views that achieves the highest utility function, e.g. U( ). In other words, a subset S is identified such that Σ_{v∈S}U(v,S−v) is maximized. The decision-making algorithm may include the following constraints: first, the utility function is not a convex function, therefore, a mathematical method may not be available to calculate the optimal solution; next, the solution set could be non-cumulative, i.e., the solution set for m views may not be based on the optimal solution set of m−1 views. Therefore, dynamic programming may not be available to solve for the subset.

Accordingly, a greedy algorithm may be implemented. The algorithm begins with the view that achieves the highest utility function. Since S=Ø at the beginning, the utility function should be considered as the IC value of each view. Therefore, the algorithm begins with the view that has highest IC value. Then at each iteration step, the next view that achieves the maximum U(v, S) is identified.

The utility function, U(v,S), of each view v with respect to a selected subset S may be defined according to Equation (5):

$$\begin{matrix}U ( v , S ) = {min}_{{v}^{′} ∈ S} IC ( v , {v}^{′} ) * D ( v , {v}^{′} ) \\ IC ( v , {v}^{′} ) = avg ( IC ( v ) , IC ( {v}^{′} ) ) \\ D ( v , {v}^{′} ) = \vert v - {v}^{′} \vert\end{matrix} \qquad Equation ( 6 )$$

Where IC(v) is the image complexity of a given view v, and where D(v,v′) is the spatial distribution between two views v, v′.

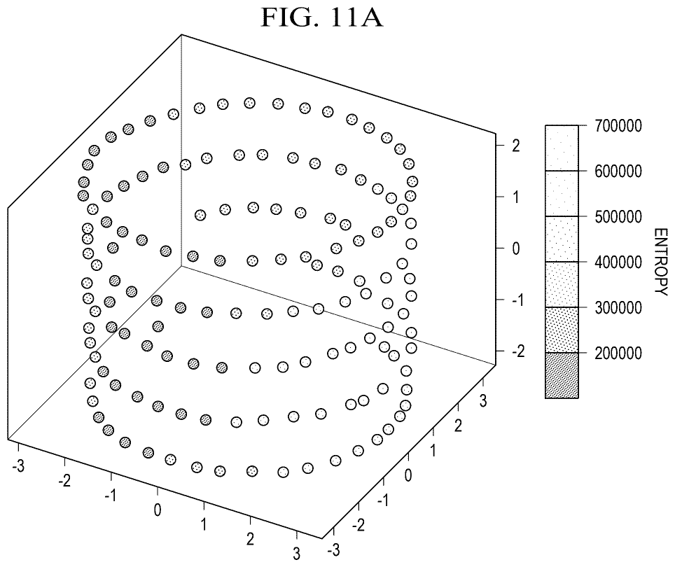

FIG. 12 illustrates example pseudocode for a greedy algorithm implemented by the decoder 908. The algorithm begins with the view that achieves the highest utility function. Since S=Ø at the beginning, in the example of FIG. 12, the utility function is considered as the IC value of each view. Therefore, the algorithm of FIG. 12 begins with the view that has highest IC value. Then at each iteration step, the next view that achieves the maximum U(v, S) is identified.

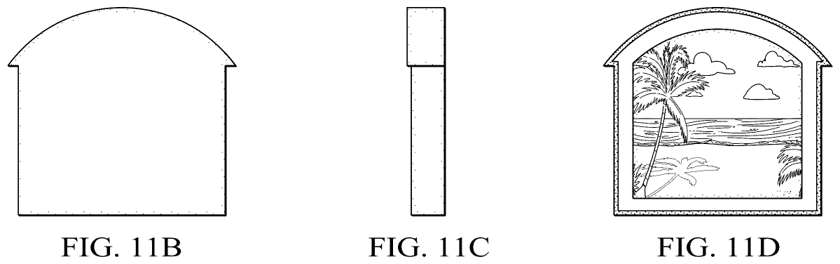

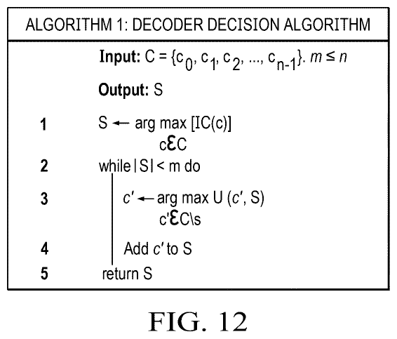

Results of a feasibility test analyzing the feasibility of example camera features and greedy algorithm with the object of FIG. 7 is shown in FIGS. 13A and 13B. FIG. 13A illustrates the peak signal-to-noise ratio (PSNR) related to the number of cameras. FIG. 13B illustrates the structural similarity index measure (SSIM) related to the number of cameras. As shown in FIGS. 13A and 13B, the test validates that the framework 900 described herein works for sparser camera views. When the camera array because more dense, the baseline performs better. In FIG. 14, the selected view positions in space are visualized. In particular, the top left view and top right view correspond to selected view positions for framework 900 with 30 and 45 cameras selected, respectively. The bottom left view and bottom right view correspond to selected view positions for the baseline with 30 and 45 cameras selected, respectively.

It may be observed that, when less views are selected, the view distribution is more uniform, with a few more views on the high-IC area. On the other hand, once more views are selected, most views will be on the high-IC area. Accordingly, in some examples, rather than a fixed utility function, a dynamic function is provided that accounts for the number of selected cameras.

An example utility function that applies a dynamic weight function to balance the importance of spatial distribution based on number of selected cameras is provided by Equation (6):

$$U ( v , S ) = {min}_{{v}^{′} ∈ S} α ( \vert S \vert , m ) * IC ( v , {v}^{′} ) * D ( v , {v}^{′} ) + ( 1 - α ( \vert S \vert , m ) ) * D ( v , {v}^{′} ) \qquad Equation ( 6 )$$

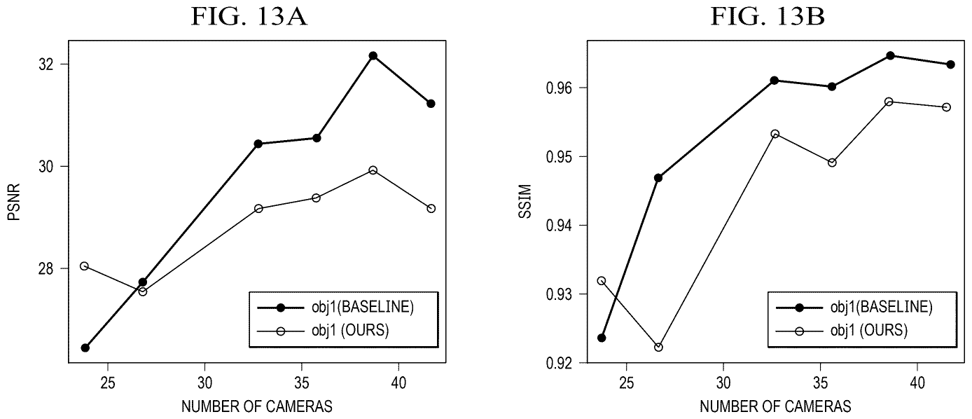

The weight function α(|S|, m) ranges from 0 to 1. When less cameras are selected, α is closer to 1, putting more importance on the image complexity in the decision. When more cameras are chosen, α is closer to 0 to put more weights on the spatial distribution and ensures the overall selected views can capture the 3D object uniformly. The sigmoid function may be selected as the α(|S|, m) (and shown in FIGS. 15A and 15R) according to Equation (7):

$$α ( \vert S \vert , m ) = 1 - \frac{1}{1 + {e}^{k * ( m - \vert S \vert )}} \qquad Equation ( 7 )$$

where k is a parameter that changes the gradient of the α curve. The parameter k may be, for example, 1. In some instances, in a first mode (Mode 1) k=0.1 and in a second mode (Mode 2) k=1. FIG. 15A illustrates the sigmoid function corresponding to the first mode. FIG. 15B illustrates the sigmoid function corresponding to the second mode.

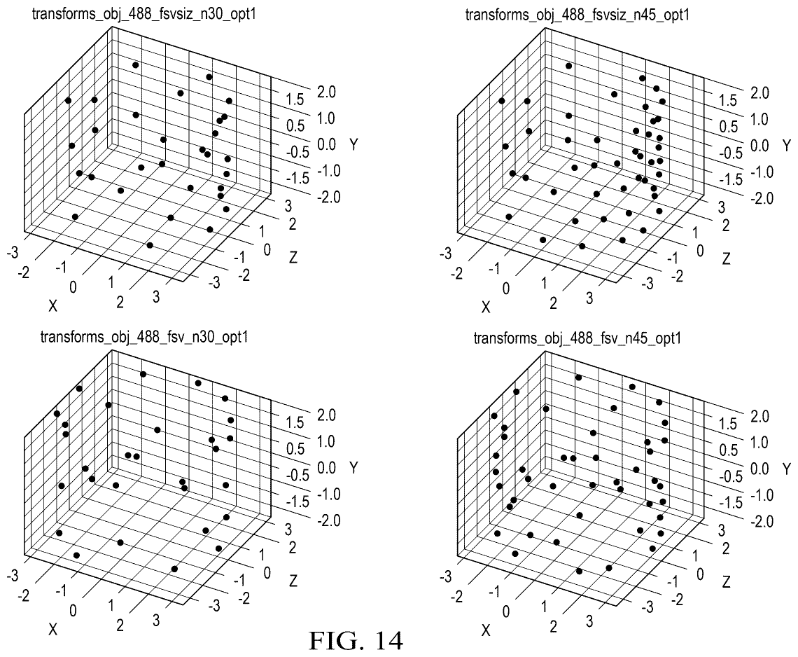

FIG. 16 provides a flow chart of a method 1600 performed by each encoder 904. The steps provided within FIG. 16 are merely examples, and may instead be conducted in a different order. Further examples of the method 1600 may include additional steps or may omit steps.

At step 1602, the encoder 904 receives a camera view 902. The camera view 902 may be associated with a particular camera included in a dense camera array.

At step 1604, the encoder 904 processes the camera view 902 to generate a camera feature 906. For example, the encoder 904 may apply multiple layers of convolutional layers and activation functions to generate a feature vector. In another example, the encoder 904 calculates the image complexity I(C) for the camera view 902. The encoder 904 may also calculate the spatial distribution D(cᵢ,cⱼ) of the camera view 902 relative to each other camera view 902 within the dense camera array.

At step 1606, the encoder 904 transmits the camera vector 906 to the decoder 908. For example, the image complexity I(C) and the spatial distribution D(cᵢ, cⱼ) are transmitted to the decoder 908.

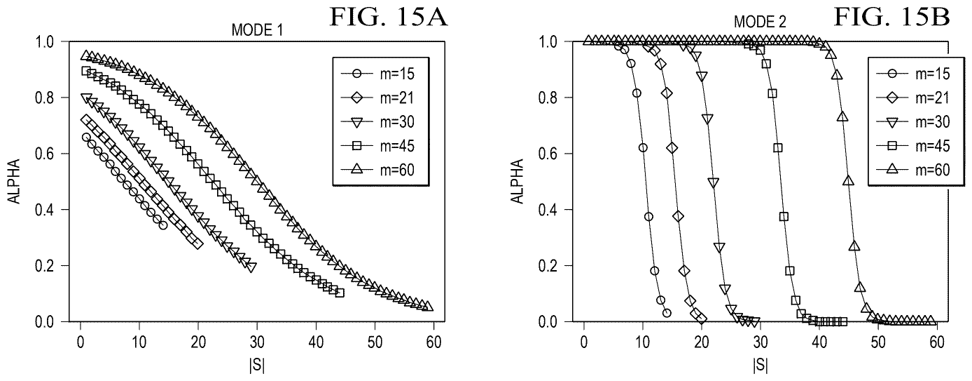

FIG. 17 provides a flow chart of a method 1700 performed by the decoder 908. The steps provided within FIG. 17 are merely examples, and may instead be conducted in a different order. Further examples of the method 1700 may include additional steps or may omit steps.

At step 1702, the decoder 908 receives a plurality of camera features 906 associated with a plurality of camera views 902. For example, each of the encoders 904 transmit a camera feature 906 to the decoder 908 that is associated with a respective camera view 902.

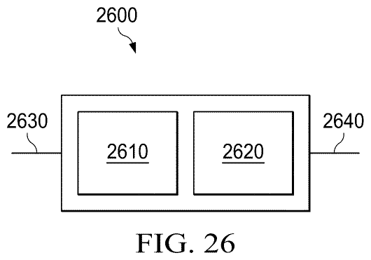

At step 1704, the decoder 908 receives a target number of cameras 912. The target number of cameras 912 may be provided by a user of the framework 900 (for example, via an input device such as a keyboard), or may be stored within a memory (for example, the memory 2600 of FIG. 26) and retrieved by the decoder 908.

At step 1706, the decoder 908 determines a subset of camera views 914 based on the plurality of camera features 906. For example, the decoder 908 performs an optimization operation to maximize a reconstruction quality Q(S) at the target number of cameras 912. The reconstruction quality Q(S) may be evaluated using SSIM values of the camera features 906, the FID of the camera features 906, the PSNR of the camera features 906, or the like. In some instances, the decoder 908 performs an optimization operation to maximize a utility function U(v, S), such as the dynamic utility function described by Equation (6).

At step 1708, the decoder 908 transmits the subset of camera views 914. For example, the subset of camera views 914 may be output to a rendering device configured to render a model captured by the plurality of camera views 902. In another implementation, the decoder 908 implements the subset of camera views 914 to render the captured object.

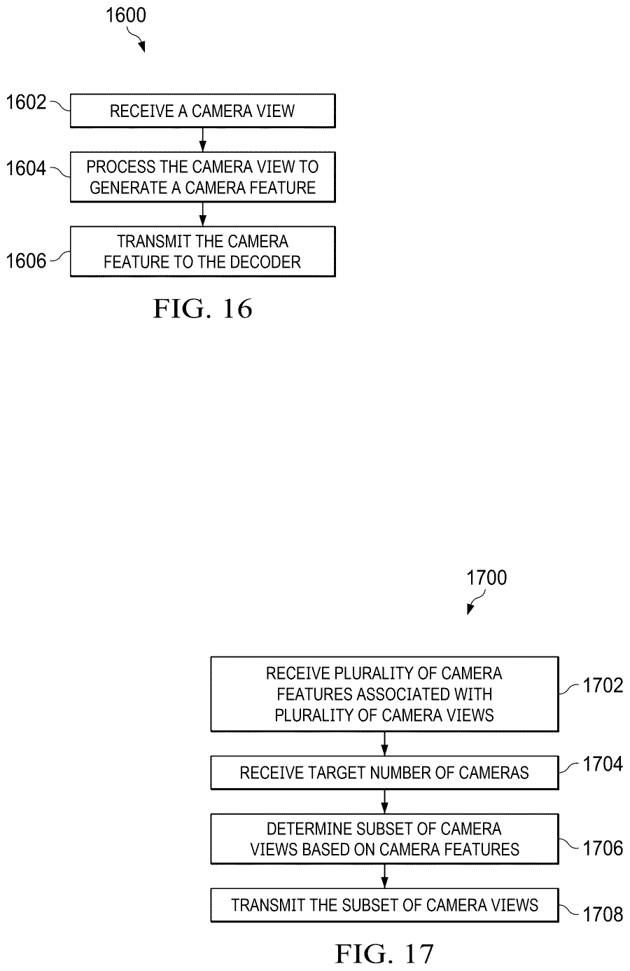

FIG. 18 provides a flowchart of a method for selecting a sparse camera view. The method 1800 may be performed by the framework 900. The steps provided within FIG. 18 are merely examples, and may instead be conducted in a different order. Further examples of the method 1800 may include additional steps or may omit steps.

At step 1802, the framework 900 receives a 3D model. For example, a plurality of cameras included in a dense camera array captures a 3D model, thereby providing a plurality of camera views 902. Each camera view 902 may provide a different view of the 3D model (for example, a view from a different angle).

At step 1804, the framework 900 identifies a reconstruction quality metric with which to construct the 3D model. For example, the encoder 904 calculates the image complexity I(C) for the camera view 902. The encoder 904 may also calculate the spatial distribution D(cᵢ,cⱼ) of the camera view 902 relative to each other camera view 902 within the dense camera array. The image complexity and the spatial distribution may be provided to the decoder 908 as a plurality of camera features 906. The decoder 908 may determine a reconstruction quality metric with which to construct the 3D model. For example, the decoder 908 may reconstruct the 3D model to maximize a PSNR of the 3D model, an SSIM of the 3D model, or the like.

At step 1806, the framework 900 selects a set of cameras that maximize the reconstruction quality metric. For example, the decoder 908 performs an optimization operation to maximize a utility function U(v, S), such as the dynamic utility function described by Equation (6). The optimization operation results in a subset of the plurality of camera views 902 being selected to reconstruct the 3D model.

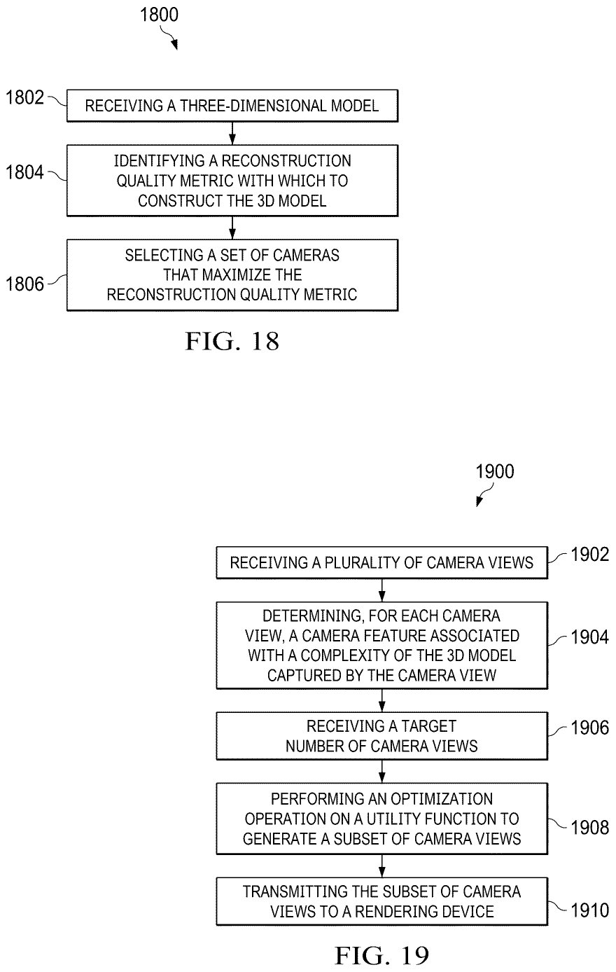

FIG. 19 provides a flowchart of another method for selecting a sparse camera view. The method 1900 may be performed by the framework 900. The steps provided within FIG. 19 are merely examples, and may instead be conducted in a different order. Further examples of the method 1900 may include additional steps or may omit steps.

At step 1902, the framework 900 receives a plurality of camera views. For example, a plurality of cameras capture an image of a 3D model from different angles, thereby generating a plurality of camera views 902.

At step 1904, the framework 900 determines, for each camera view 902, a camera feature 906 associated with a complexity of the 3D model captured by the camera view 902. For example, the encoder 904 calculates the image complexity I(C) for the camera view 902. The encoder 904 may also calculate the spatial distribution D(cᵢ, cⱼ) of the camera view 902 relative to each other camera view 902 within the dense camera array. The image complexity and the spatial distribution of the camera views 902 are included as camera features 906.

At step 1906, the framework 900 receives a target number of camera views. For example, the decoder 908 receives the target number of cameras 912.

At step 1908, the framework 900 performs an optimization operation on a utility function to generate a subset of camera views 914. For example, the decoder 908 performs an optimization operation to maximize a reconstruction quality Q(S) at the target number of cameras 912. The reconstruction quality Q(S) may be evaluated using SSIM values of the camera features 906, the FID of the camera features 906, the PSNR of the camera features 906, or the like. In some instances, the decoder 908 performs an optimization operation to maximize a utility function U(v,S), such as the dynamic utility function described by Equation (6).

At step 1910, the framework 900 transmits the subset of camera views 914 to a rendering device. For example, the subset of camera views 914 may be output to a rendering device configured to render a model captured by the plurality of camera views 902. In another implementation, the decoder 908 implements the subset of camera views 914 to render the captured object.

### Implementation and Evaluation

NeRF Model: An Instant-NGP model may be implemented as a backbone model, while NeRF Studio may be implemented for training models and generating rendering outputs.

Evaluation Dataset: Example objects include objects of various complexities, including at least one scene with multiple objects. All objects and scenes are scaled to fit inside a 1 m×1 m×1 m unit bounding box as a ground truth.

Framework: The framework may be implemented with Python and both alpha functions as previously described.

Baseline: The furthest view sampling (FVS) algorithm in NeRF Direction may be selected as the baseline. FVS selects cameras that are uniformly distributed in space as the suggested view selection. In other words, FVS only considers spatial distribution (D(v, v′)) as the utility function. Note that the original FVS design starts with a random sampled camera. To make the results reproducible and trackable, the same starting camera is used for FVS across all evaluations.

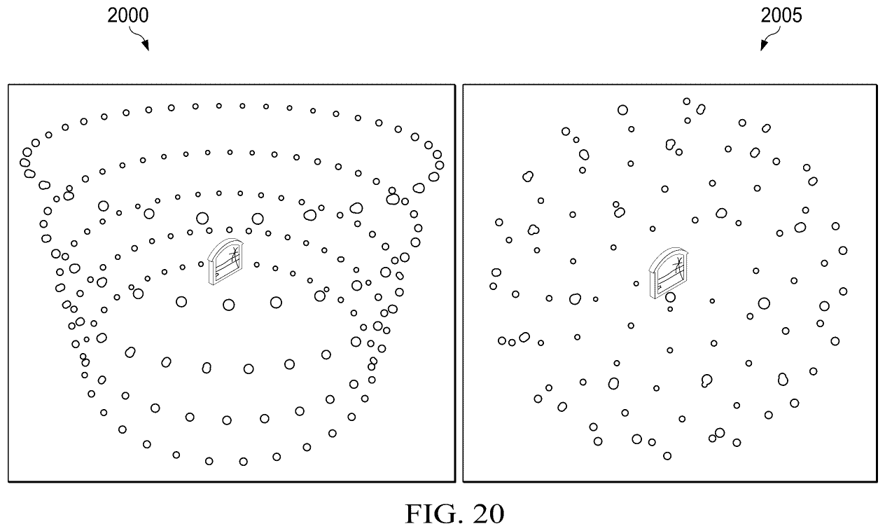

Camera Configuration: A 36*5 matrix of cameras is selected on the surface of a cylinder of radius 3 m, centering at the bounding box as the set of candidates views to select from. Considering that the selected number of cameras changed, a different set of cameras is used for evaluation to ensure a fair compare. The N=100 Tammes Views is selected on a sphere of radius 3 m centered at the bounding box as the evaluation view set. FIG. 20 shows the candidate views' 2000 and evaluation views' position 2005.

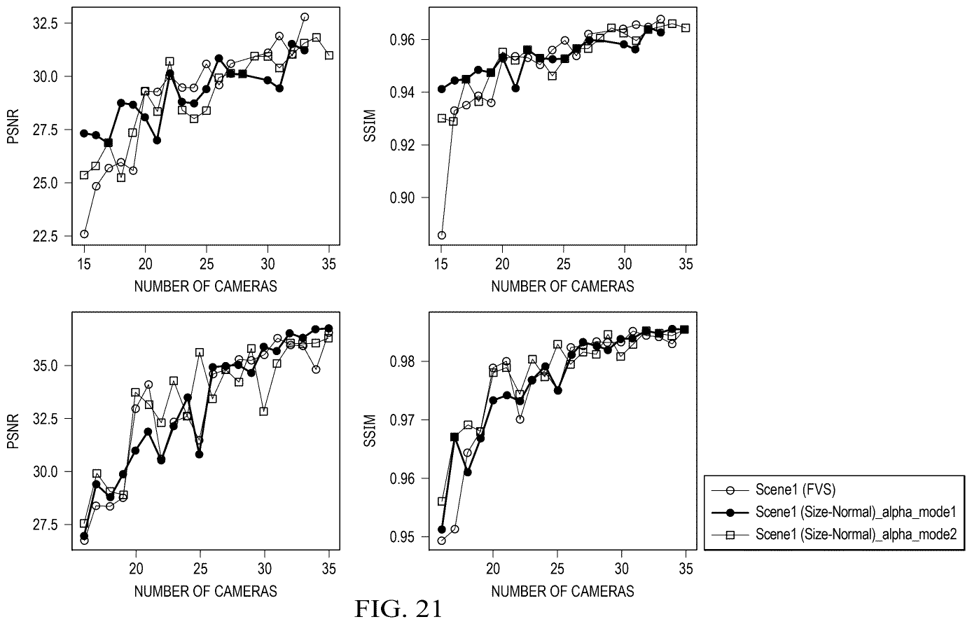

The evaluation results with several single objects are presented in FIG. 21. Specifically, the PSNR and SSIM values of several objects are provided in FIG. 21. On average, the proposed framework can improve the PSNR and SSIM value by approximately 12.3%, 21.8%, 13.3%, and 25.5% for objects 1, 2, 3, and 4 respectively. With more cameras, the framework described herein bears the same level of PSNR and SSIM value. The framework described herein works well even when very limited number of views are selected. When more views are selected, both baseline and our framework perform well on reconstructing the 3D object.

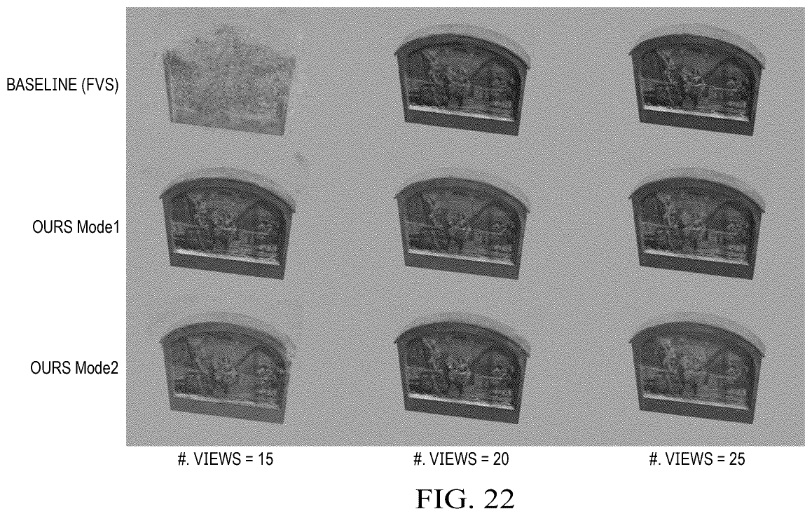

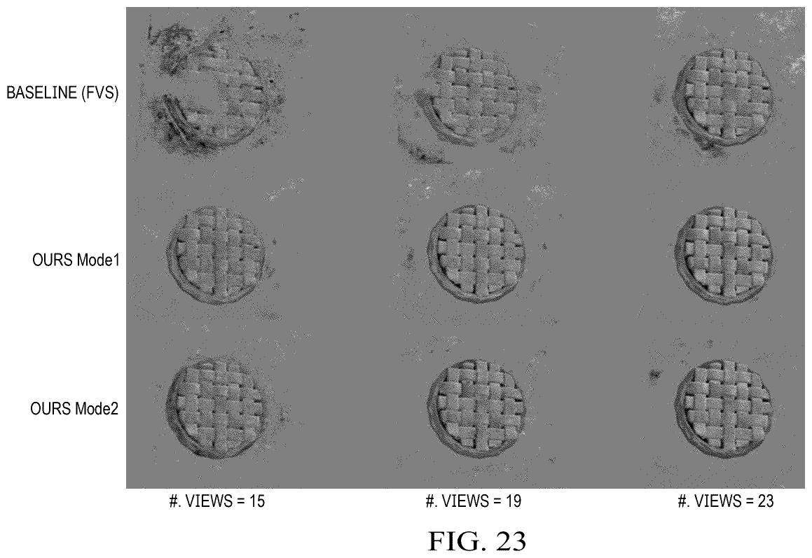

The visualization of example objects are provided in FIG. 22 and FIG. 23 with different view counts. As shown in FIG. 22 and FIG. 23, when less views are selected, the models do not reconstruct well, either with large group of noise or not converged at all. On the other hand, the proposed framework works well even when a very limited number of views are selected.

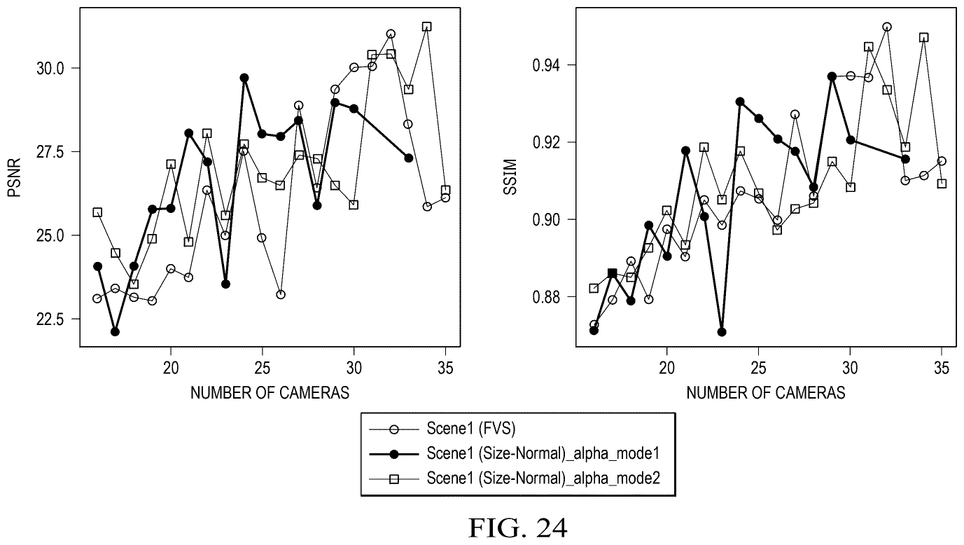

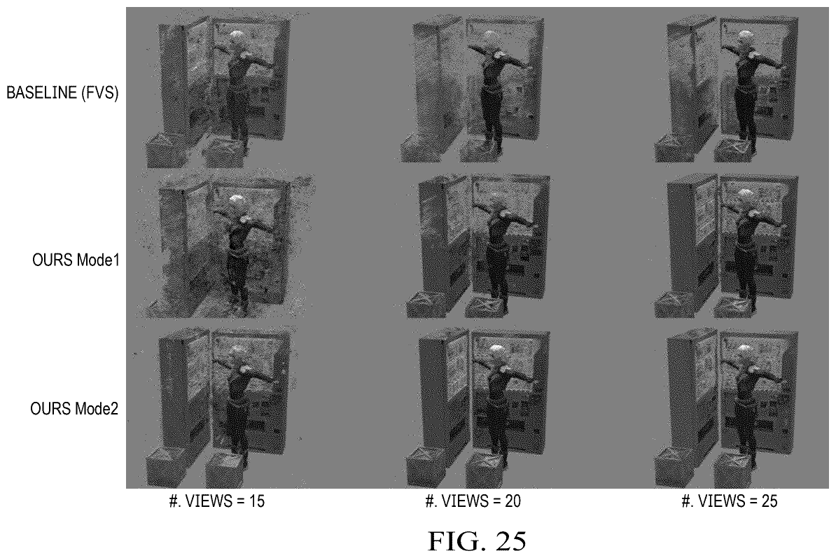

Evaluation results are also provided for more complex scenes, such as the scene previously shown in FIG. 8. Complex scenes consist of multiple objects occluding each other and represent a real-world capture scenario better than the single objects. FIG. 24 shows the PSNR and SSIM values of the complex scene of FIG. 8. On average, the framework described herein performs the best, with an average improvement of 6% in PSNR value. The visualization of the complex scene with different view counts is shown in FIG. 25. The framework described herein reconstructs the scene well with as few as 15 views, whereas the baselines struggles at generating a complete model even at 25 views.

FIG. 26 illustrates a block diagram of an example apparatus 2600. In particular, apparatus 2600 includes an electronic processor 2610 and a memory 2620 coupled to the electronic processor 2610. The memory 2620 may store instructions for the electronic processor 2610. The electronic processor 2610 may also receive, among others, suitable input data 2630 (e.g., the camera views 902, etc.), depending on use cases and/or implementations. The electronic processor 2610 may be adapted to carry out or implement the methods/techniques described throughout the present disclosure and to generate corresponding output data 2640 (e.g., the target number of cameras 912), depending on use cases and/or implementations. For example, the electronic processor 2610 may carry out or implement the method 1600 of FIG. 16, the method 1700 of FIG. 17, the method 1800 of FIG. 18, and/or the method 1900 of FIG. 19.

In some examples, the memory 2620 may be located internal to the electronic processor 2610, such as for an internal cache memory or some other internally located ROM, RAM, or flash memory. In other examples, memory 2620 may be located external to the electronic processor 2610, such as a ROM, a RAM, flash memory or a removable medium, or another non-transitory computer readable medium. The memory 2620 may store instructions implemented by the electronic processor 2610 to perform the methods described throughout the present disclosure. For example, the memory 2620 may store instructions that, when implemented by the electronic processor 2610, cause the electronic processor 2610 to perform the method 1600 of FIG. 16, the method 1700 of FIG. 17, the method 1800 of FIG. 18, and/or the method 1900 of FIG. 19.

Systems, methods, and devices in accordance with the present disclosure may take any one or more of the following configurations.
Clause 1. A method for selecting a camera configuration, the method comprising: receiving a three-dimensional (3D) model; identifying a reconstruction quality metric with which to reconstruct the 3D model; and selecting a set of cameras, each camera having a different view of the 3D model, that maximize the reconstruction quality metric, wherein a number of cameras in the set of cameras is less than a total number of available cameras.
Clause 2. The method of clause 1, wherein the 3D model is included in a volumetric video.
Clause 3. The method of any of clauses 1-2, wherein the reconstruction quality metric is a Peak Signal-to-Noise Ratio (PSNR).
Clause 4. The method of any of clauses 1-2, wherein the reconstruction quality metric is a Structural Similarity Index Measure (SSIM).
Clause 5. The method of any of clauses 1-4, wherein the different views of the set of cameras are Tammes views.
Clause 6. The method of any of clauses 1-5, wherein selecting the set of cameras includes reconstructing the 3D model using a NeRF model.
Clause 7. The method of any of clauses 1-6, wherein the set of cameras are spaced unevenly around the 3D model.
Clause 8. The method of any of clauses 1-7, wherein selecting the set of cameras includes identifying a subset of a plurality of cameras that achieves a highest value of a utility function U( ).
Clause 9. A method for selecting a camera configuration, the method comprising: receiving a plurality of camera views, each camera view associated with a camera included in an array of cameras capturing a three-dimensional (3D) model; determining, for each camera view of the plurality of camera views, a camera feature associated with a complexity of the 3D model captured by the camera view; receiving a target number of camera views; performing an optimization operation on a utility function to generate a subset of camera views, wherein the utility function is based on the complexity of the 3D model captured by each camera view, a spatial distribution between the plurality of camera views, and the target number of camera views; and transmitting the subset of camera views to a rendering device.
Clause 10. The method of clause 9, wherein the utility function includes a weight function based on the target number of camera views.
Clause 11. The method of any of clauses 9-10, wherein the plurality of camera views are Tammes views.
Clause 12. The method of any of clauses 9-11, wherein the subset of camera views are spaced unevenly around the 3D model.
Clause 13. The method of any of clauses 9-12, wherein the complexity of the 3D model captured by each camera view includes spatial information indicative of an energy of edges captured by the respective camera view.
Clause 14. The method of any of clauses 9-13, further comprising repeating the step of performing the optimization operation on the utility function to generate the subset of camera views after a predetermined number of frames captured by the plurality of camera views.
Clause 15. A method of encoding a three-dimensional (3D) model, the method comprising: receiving a camera view capturing the 3D model; generating a camera feature representative of an image complexity and spatial distribution associated with the camera view; and transmitting the camera feature to a decoding device.
Clause 16. The method of clause 15, wherein the image complexity includes a compression ratio of the camera view.
Clause 17. The method of any of clauses 15-16, wherein the spatial distribution includes a Euclidean distance between the camera view and a second camera view included in a plurality of camera views capturing the 3D model.
Clause 18. The method of any of clauses 15-17, wherein the complexity of the camera view includes spatial information indicative of an energy of edges within the 3D model captured by the camera view.
Clause 19. The method of any of clauses 15-18, wherein generating the camera feature includes: generating a normal map of the camera view; and evaluating the image complexity using the normal map.
Clause 20. A method for selecting a camera configuration, the method comprising: receiving a plurality of camera features associated with a plurality of camera views; receiving a target number of cameras less than a total number of the plurality of camera views; determining a subset of camera views based on the camera features, wherein a number of camera views included in the subset of camera views is equal to the target number of cameras; and transmitting the subset of camera views to a rendering device.
Clause 21. The method of clause 20, wherein each camera feature is associated with a complexity of a 3D model captured by the associated camera view.
Clause 22. The method of clause 21, wherein the complexity of the 3D model includes spatial information indicative of an energy of edges captured by the associated camera view.
Clause 23. The method of any of clauses 20-22, wherein determining the subset of camera views based on the camera features includes maximizing a reconstruction quality of a 3D model captured by the plurality of camera views at the target number of cameras.
Clause 24. The method of any of clauses 20-23, wherein determining the subset of camera views based on the camera features includes providing the plurality of camera features to a dynamic utility function dependent on the plurality of camera features and the target number of camera views.
Clause 25. A program comprising instructions that, when executed by a processor, cause the processor to carry out the method according to any one of clauses 1-24.
Clause 26. A non-transitory computer-readable storage medium storing the program according to clause 25.

The present disclosure likewise relates to corresponding computer programs, computer program products, and computer-readable storage media storing such computer programs or computer program products. Additionally, various blocks shown in the flowcharts may be viewed as method steps, and/or as operations that result from operation of computer program code, and/or as a plurality of coupled logic circuit elements constructed to carry out the associated function(s). For example, embodiments of the present disclosure include a computer program product including a computer program tangibly embodied on a machine readable medium, the computer program containing program codes configured to carry out the methods as described above.

Aspects of the methods and apparatus/systems described herein may be implemented in an appropriate computer-based audio processing network environment (e.g., server or cloud environment) for processing digital or digitized audio files. Portions of the audio system may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

One or more of the components, blocks, processes or other functional components (modules) may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

Specifically, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software-based devices, as well as a plurality of different structural components, may be utilized to implement the embodiments. For example, the apparatus (e.g., encoders) described above can include one or more electronic processors, one or more computer-readable medium modules, one or more input/output interfaces, and various connections (e.g., a system bus) connecting the various components.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in fewer than all features of a single disclosed embodiment. Thus, the following claims are hereby incorporated into the Detailed Description, with each claim standing on its own as a separately claimed subject matter.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments may be implemented as circuit-based processes, including possible implementation on a single integrated circuit.

Some embodiments can be embodied in the form of methods and apparatuses for practicing those methods. Some embodiments can also be embodied in the form of program code recorded in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the patented invention(s). Some embodiments can also be embodied in the form of program code, for example, stored in a non-transitory machine-readable storage medium including being loaded into and/or executed by a machine, wherein, when the program code is loaded into and executed by a machine, such as a computer or a processor, the machine becomes an apparatus for practicing the patented invention(s). When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term compatible means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. A method for selecting a camera configuration for generating volumetric video, the method comprising:
receiving a plurality of camera views, each camera view associated with a camera included in an array of cameras capturing a three-dimensional (3D) scene;
determining, for each camera view of the plurality of camera views, a camera feature associated with an image complexity of the image captured by the camera view;
receiving a target number of camera views, the target number smaller than the number of camera views in the plurality of camera views; and
performing an optimization operation on a utility function to generate a subset of camera views, wherein the utility function for each camera view of the plurality of camera views is based on the image complexity of the image of the 3D scene captured by the camera view, the spatial distance between the camera view and one or more selected camera views, and the target number of camera views.

2. The method of claim 1, further comprising:
training a neural radiance field (NeRF)-based volumetric representation of the 3D scene based on the generated subset of camera views of the 3D scene.

3. The method of claim 1, wherein performing the optimization operation comprises:
selecting, as a first camera view of the subset of selected camera views, the camera view for which the image complexity is maximized; and
iteratively updating the subset of selected camera views to include the unselected camera view that maximises the utility function until the target number of camera views is reached.

4. The method of claim 3, wherein the utility function for a camera view v with respect to a subset S of selected camera views is calculated as:
$$U ( v , S ) = {min}_{{v}^{′} ∈ S} IC ( v , {v}^{′} ) * D ( v , {v}^{′} ) ,$$
where IC(v, v′) is an average image complexity of the camera views v, v′ and wherein D(v, v′) is a measure of spatial distance between the camera views v and v′.

5. The method of claim 1, wherein the utility function includes a weight function based on the target number of camera views.

6. The method of claim 5, wherein the utility function for a camera view v with respect to a subset S of selected camera views is calculated as:
$$U ( v , S ) = {min}_{{v}^{′} ∈ S} α ( \vert S \vert , m ) * IC ( v , {v}^{′} ) * D ( v , {v}^{′} ) + ( 1 - α ( \vert S \vert , m ) ) * D ( v , {v}^{′} )$$
where α(|S|, m) is a weight function ranging from 0 to 1 and defined such that α is closer to 1 when less cameras are selected.

7. The method of claim 1, wherein the plurality of camera views are approximately uniformly distributed over a spherical surface of a space centered on the 3D scene.

8. The method of claim 1, wherein the complexity of the 3D scene captured by each camera view includes spatial information indicative of an energy of edges in the image captured by the respective camera view.

9. The method of claim 1, further comprising repeating the step of performing the optimization operation on the utility function to generate the subset of camera views after a predetermined number of frames captured by the plurality of camera views.

10. A method of encoding a three-dimensional (3D) scene, the method comprising:
receiving a camera view capturing the 3D scene;
generating a camera feature representative of an image complexity of the image captured by the camera view and spatial distance between the camera view and one or more other camera views; and
transmitting the camera feature to a decoding device.

11. The method of claim 10, wherein the image complexity includes a compression ratio of the camera view.

12. The method of claim 10, wherein the spatial distribution includes a Euclidean distance between the camera view and a second camera view included in a plurality of camera views capturing the 3D scene.

13. The method of claim 10, wherein the complexity of the image captured by the camera view includes spatial information indicative of an energy of edges within the 3D scene captured by the camera view.

14. The method of claim 10, wherein generating the camera feature includes:
generating a normal map of the camera view; and
evaluating the image complexity using the normal map.

15. A method for selecting a camera configuration, the method comprising:
receiving a plurality of camera features associated with a plurality of camera views capturing a three-dimensional (3D) scene, wherein the camera features for a camera view are representative of an image complexity associated with the camera view and spatial distance between the camera view and one or more selected camera views;
receiving a target number of cameras less than a total number of the plurality of camera views; and
determining a subset of camera views based on the camera features, wherein a number of camera views included in the subset of camera views is equal to the target number of cameras by performing an optimization operation on a utility function to generate a subset of camera views, wherein the utility function for a given camera view of the plurality of camera views is based on the image complexity, the spatial distance between the camera view and one or more selected camera views, and the target number of camera views.

16. The method of claim 15, further comprising:
training a neural radiance field (NeRF)-based volumetric representation of the 3D scene based on the generated subset of camera views of the 3D scene.

17. The method of claim 15, wherein performing the optimization operation comprises:
selecting, as a first camera view of the subset of selected camera views, the camera view for which the image complexity is maximized; and
iteratively updating the subset of selected camera views to include the unselected camera view that maximises the utility function until the target number of camera views is reached.

18. The method of claim 16, wherein the utility function for a camera view v with respect to a subset S of selected camera views is calculated as:
$$U ( v , S ) = {min}_{{v}^{′} ∈ S} IC ( v , {v}^{′} ) * D ( v , {v}^{′} ) ,$$
where IC(v, v′) is an average image complexity of the camera views v, v′ and wherein D(v, v′) is a measure of spatial distance between the camera views v and v′.

19. The method of claim 15, wherein the image complexity includes spatial information indicative of an energy of edges captured by the associated camera view.
